(19) United States
(12) Patent Application Publication
(10) Pub. No.: US 2014/0020959 A1
(43) Pub. Date: Jan. 23, 2014

(54) Trash Auto-Weighing

(71) Applicant: Uster Technologies AG, Uster (CH)

(72) Inventors: Yazhou Liu, Suzhou (CN); Jonathan W. Craps, Kodak, TN (US); Weichang Zhao, Oak Ridge, TN (US); William C. Easterday, Jefferson City, TN (US); Peyman Dehkordi, Knoxville, TN (US); Hossein M. Ghorashi, Knoxville, TN (US)

(21) Appl. No.: 13/944,967

(22) Filed: Jul. 18, 2013

(30) Foreign Application Priority Data
Jul. 19, 2012 (CN) 201210251021.1

(51) Int. Cl. G01G 19/00

(52) U.S. Cl. CPC G01G 19/00
USPC 177/1; 177/245; 177/262

(57) ABSTRACT

The weighing apparatus is for automatically weighing trash that is separated from a fiber sample. It includes a scale, a weigh pan disposed on the scale, a cleaner for passing a cleaning element across a surface of the weigh pan when the scale is not taking a weight measurement, and a controller for selectively controlling operations and sequencing of the scale and the cleaner.

### FIELD

This invention relates to the field of fiber quality measurement. More particularly, this invention relates to automatically weighing trash that is separated from a fiber sample.

### INTRODUCTION

Fibers can be graded of one or more of a variety of different factors. One factor that is sometimes considered is the cleanliness of the fibers. For example, raw cotton fibers typically have some amount of non-lint material mixed in with them, all of which is generally referred to as trash herein. In general, the higher the trash content of a given fiber sample, the lower the grading of the fiber sample. Thus, the measurement of trash within a fiber sample is an important task. Unfortunately, such measurements tend to be highly manual in nature, which tend to make them relatively expensive and lengthy to perform, resulting in low precision and operator dependency.

The fiber samples contemplated in some grading applications might be quite small, and thus the trash that might be contained therein could be on the order of a few grams. Therefore, the scale that is selected to weigh the trash might need to be extremely sensitive, so that an accurate determination of the weight of the trash can be made. Such scales tend to be damaged by physical contact that is abrupt or greatly in excess of the desired weight range, even if only applied momentarily. Manually loading and unloading the weigh pan of such a scale can dramatically reduce the utile life of the scale.

What is needed, therefore, is a system that generally addresses situations such as those described above, at least in part.

### SUMMARY

The above and other needs are met by a weighing apparatus for automatically weighing trash that is separated from a fiber sample. The apparatus includes a scale, a weigh pan disposed on the scale, a cleaner for passing a cleaning element across a surface of the weigh pan when the scale is not taking a weight measurement, and a controller for selectively controlling operations and sequencing of the scale and the cleaner.

In various embodiments according to this aspect of the invention, the cleaning element includes at least one of a brush, an air flow from a stationary air knife, a moving air nozzle, and a moving vacuum nozzle. In some embodiments, a lifting device raises the weigh pan off of the scale during cleaning cycles, and lowers the weigh pan on to the scale during weighing cycles. In some embodiments, the lifting device physically disengages from the weigh pan during the weighing cycles. In some embodiments, the lifting device includes at least one of a set of rotating cams and a set of pneumatic cylinders. In some embodiments, a barrier selectively isolates the weigh pan from air currents during weighing cycles. In some embodiments, the barrier includes at least one of a rigid barrier and a cloth barrier. In some embodiments, a receptacle receives trash that is removed from the weigh pan by the cleaner. In some embodiments, a vacuum source is connected to the receptacle for drawing away the trash that is removed from the weigh pan by the cleaner. In some embodiments, the weigh pan includes a box with openings in the top, first end, and opposing second end. In some embodiments, the cleaner is an air knife and the controller selectively controls the air knife to produce a first air flow with a first velocity and then a second air flow with a second velocity, where the first velocity is lower than the second velocity.

The method for automatically weighing trash that is separated from a fiber sample comprises the steps of receiving a first weight measurement from a scale with a controller at a first point in time when a weigh pan on the scale is free of trash, then collecting trash on the weigh pan, then receiving a second weight measurement from the scale with the controller at a second point in time when the weigh pan on the scale has collected the trash, and then passing a cleaning element across the weigh pan using a cleaner, so as to remove substantially all of the collected trash from the weigh pan. The first weight measurement is subtracted from the second weight measurement to yield a weight of the collected material.

In various embodiments according to this aspect of the invention, the cleaning element includes at least one of a brush, an air flow from a stationary air knife, a moving air nozzle, and a moving vacuum nozzle. In some embodiments the weigh pan is lifted off of the scale with a lifting device during cleaning cycles and lowered on to the scale with the lifting device during weighing cycles. In some embodiments the lifting device physically disengages from the weigh pan during the weighing cycles. In some embodiments the trash that is removed from the weigh pan by the cleaner is drawn away with a receptacle that is connected to a vacuum source. In some embodiments the vacuum source that is connected to the receptacle produces a substantially turbulent flow of air within at least a portion of the weigh pan. In some embodiments the cleaner is an air knife, and a controller selectively controls the air knife to produce a first air flow with a first velocity and then a second air flow with a second velocity, where the first velocity is lower than the second velocity. In some embodiments the cleaner is an air knife, and an air pressure that is applied to the air knife produces a substantially laminar flow of air within at least a portion of the weigh pan that is substantially parallel to and adjacent a bottom of the weigh pan.

Comparing to the conventional manual trash weight measurement, the automatic measurement according to the invention has many advantages: (1) the cost of performing test might decrease due to less human involvement; (2) the volume of samples might increase due to higher test speed; and (3) the precision and objectiveness of test results might be higher due to less human intervention.

### DRAWINGS

Further advantages of the invention are apparent by reference to the detailed description when considered in conjunction with the figures, which are not to scale so as to more clearly show the details, wherein like reference numbers indicate like elements throughout the several views, and wherein:

FIG. 1 is a functional block diagram of a weighing apparatus of an embodiment of the present invention.

FIG. 2 is perspective diagram of a weigh pan of an embodiment of the present invention.

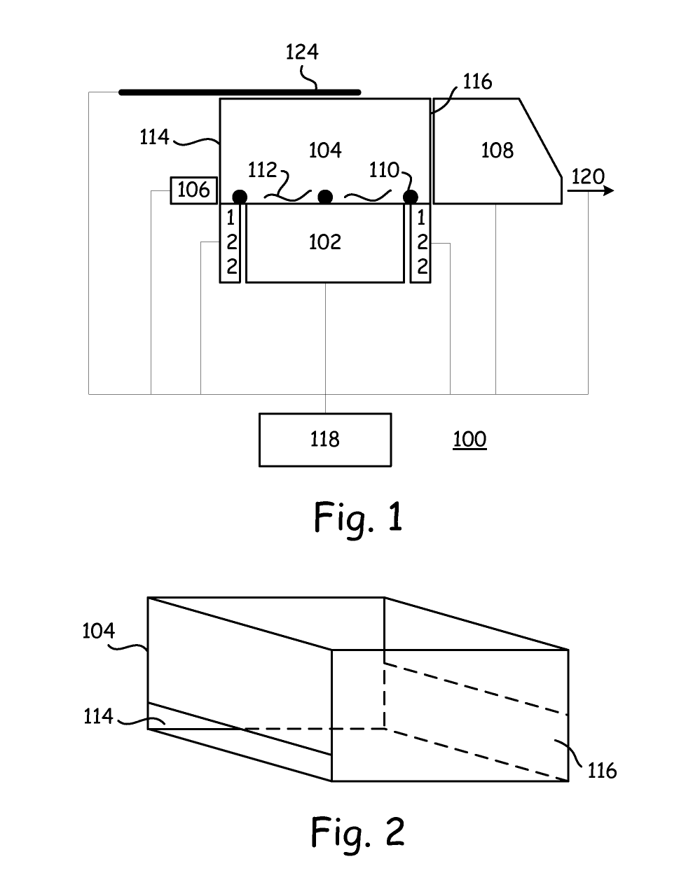

### DESCRIPTION

With reference now to the figures, there is depicted a weighing apparatus 100, including a scale 102, a weigh pan 104, a cleaner 106, a receptacle 108, and a controller 118. In one embodiment, the weighing apparatus 100 is used to weigh the trash 110 that is separated from a fiber sample of fibers 112 and trash 110. The fibers 112 of the fiber sample are separated from the trash 110 of the fiber sample at a position that is disposed gravitationally above the weigh pan 104. The fibers 112 of the fiber sample are predominantly removed along a different path, and the trash 110 of the fiber sample falls onto the weigh pan 104, to be weighed. However, the separation of the fibers 112 from the trash 110 is typically not complete, and so some amount of fiber 112 might be present on the weigh pan 104 with the trash 110.

In the embodiment as depicted, the cleaner 106 is operable to pass a cleaning element across the surface of the weigh pan 104, in such a manner as to remove both fibers 112 and trash 110 from the weigh pan 104. In this manner, the weight of any material on the scale 102 (such as trash 110 and fibers 112) can be measured and then automatically removed from the weigh pan 104 by the cleaner 106, so that the cleaned-off scale 102 can be tared and prepared for the next weighing cycle without any human intervention. Thus, in some embodiments the scale 102 is an electronic scale 102 that is connected to a controller 118, which receives weight readings from the scale 102, and controls the coordinated operation of other elements of the weighing apparatus 100, such as the cleaner 106 and the receptacle 108.

The cleaning element that is passed by the cleaner 106 across the surface of the weigh pan 104 can be different in different embodiments. For example, in one embodiment the cleaning element is a brush, and the cleaner 106 is a wand that passes horizontally across the surface of the weigh pan 104, sweeping the fibers 112 and trash 110 off of the surface of the weigh pan 104 in front of it as it passes, thereby cleaning the weigh pan 104 without exerting undue force upon the scale 102.

In another embodiment the cleaning element is a vacuum nozzle, and the cleaner 106 is a wand that passes horizontally across the surface of the weigh pan 104, sucking the fibers 112 and trash 110 off of the surface of the weigh pan 104 as it passes, thereby cleaning the weigh pan 104 without exerting undue force upon the scale 102.

In another embodiment the cleaning element is an air nozzle, and the cleaner 106 is a wand that passes horizontally across the surface of the weigh pan 104, blowing the fibers 112 and trash 110 off of the surface of the weigh pan 104 in front of it as it passes, thereby cleaning the weigh pan 104 without exerting undue force upon the scale 102.

In yet another embodiment, the cleaning element is a flow of air, and the cleaner 106 is a stationary blower that passes the flow of air horizontally across the surface of the weigh pan 104, blowing the fibers 112 and trash 110 off of the surface of the weigh pan 104 in front of it as it passes across the surface, thereby cleaning the weigh pan 104 without exerting undue force upon the scale 102. This embodiment is generally referred to herein as an air knife.

In some embodiments, some or all of these elements are combined, and the cleaning element includes, for example, a brush, a vacuum nozzle, and an air nozzle combined within the cleaner 106, which passes horizontally across the surface of the weigh pan 104, sucking, blowing, and sweeping the fibers 112 and trash 110 off of the surface of the weigh pan 104 as it passes, thereby cleaning the weigh pan 104 without exerting undue force upon the scale 102.

Some embodiments include a receptacle 108 that receives the fibers 112 and the trash 110 that are either blown or swept by the cleaner 106 from the weigh pan 104. In some embodiments, the receptacle 108 is connected to a vacuum source 120, which aids in the removal of the fibers 112 and trash 110 from the weighing apparatus 100.

In some embodiments the weigh pan 104 is a box having a first end 114 disposed near the cleaner 106 and an opposing second end 116 disposed near the receptacle 108. In some embodiments the box has a first opening on the first end 114, a second opening on the second end 116, and a third opening on the top to receive fibers 112 and trash 110.

In one embodiment, the air knife 106 is disposed at the first end 114 of the box 104, and blows material collected by the box 104 out of the box 104. The receptacle 108 receives the material that is blown out of the box 104. In some embodiments the opening in the first end 114 of the box 104 is sized to substantially match an air exit port of the air knife 106. In some embodiments, the air exit port of the air knife 106 extends substantially completely across a width of the box 104. In some embodiments the width is about thirty centimeters.

In some embodiments the opening in the second end 116 is sized to substantially match an air entry port of the receptacle 108. In some embodiments the air entry port of the receptacle 108 extends substantially completely across a height of the second end 116 of the box 104. In some embodiments the height is about eight centimeters. In some embodiments the air entry port of the receptacle 108 extends substantially completely across a width of the second end 116 of the box 104. In some embodiments the width is about thirty centimeters.

A method of using the weighing apparatus 100 of one embodiment of the present invention is now described. The controller 118 receives a reading from the scale 102 at a point in time that the weigh pan 104 has been cleaned of material, which reading is designated as the tare weight of the empty weigh pan 104. The empty weigh pan 104 receives material, such as fibers 112 and trash 110, from above the weigh pan 104. The controller 118 receives a reading from the scale 102, which reading is designated as the gross weight of the weigh pan 104 and any material residing thereon. The tare weight is subtracted from the gross weight, which yields the weight of whatever material is disposed on the weigh pan 104.

After the weight of the material is thus obtained, a vacuum is applied to the receptacle 108, an air pressure is applied to the air knife 106, and any material residing thereon is cooperatively blown and suctioned out of the weigh pan 104. The air pressure to the air knife 106 is stopped, and the vacuum to the receptacle 108 is likewise stopped. In this manner, any trash 110 and fibers 112 residing on the weigh pan 104 are automatically removed, and the weighing apparatus 100 is ready to start the cycle from the beginning, as described above.

In some embodiments the vacuum is applied to the receptacle 108 for about two seconds before the air pressure is applied to the air knife 106. In some embodiments the air pressure is removed from the air knife 106 for about two seconds before the vacuum is removed from the receptacle 108. In some embodiments the air pressure is applied to the air knife 106 for less than about one second.

In some embodiments the air pressure applied to the air knife 106 produces a substantially laminar flow of air within at least a portion of the weigh pan 104. In some embodiments the substantially laminar flow of air is substantially parallel to and adjacent the bottom of the weigh pan 104. In some embodiments the vacuum applied to the receptacle 108 produces a substantially turbulent flow of air within at least a portion of the weigh pan 104.

In some embodiments the air pressure applied to the air knife 106 is stepped or otherwise graduated from a lower air flow velocity to a greater air flow velocity over time, or from a greater air flow velocity to a lower air flow velocity over time. This can be accomplished in various steps, gradients, or times. For example, in one embodiment a first air flow can be initiated at a first velocity for a first length of time, which is sufficient to remove only the fibers 112 that might be disposed upon the weigh pan 104. Then a second air flow can be initiated at a second velocity for a second length of time, which is sufficient to remove anything else, such as the trash 110, that might be disposed upon the weigh pan 104. In this manner, a blast of air sufficient to remove the trash 110 is not initially used, which blast might cause the fibers 112 to blow around inside either the weighing apparatus 100 or other portions of the system in which the weighing apparatus 100 might be disposed.

Such steps or graduation can also be used with some of the other embodiments of the cleaner 106, such as the air nozzles or suction nozzles that are passed across the surface of the weigh pan 104 as the cleaner 106 passes over the surface of the weigh pan 104.

In some embodiments, there is no air flow from the air knife 106 between the first air flow and the second air flow, and a third weight measurement is taken between the first air flow and the second air flow, and received by the controller 118. This third weight measurement is also subtracted from the gross weight, which in some embodiments make the measurement of the trash weight more accurate. Such a third measurement can also be used to gain information in regard to the efficiency of the separation process that is used to separate the fibers 112 from the trash 110.

In some embodiments more than two air flows are used, with some combination of different air velocities or lengths of time or flow volumes. In some embodiments that air flow is continuous, but varies in one or more of these air flow properties over time.

In some embodiments the weigh pan 104 and scale 102 are selectively isolated from the rest of the system in which the weighing apparatus 100 is disposed. For example, a barrier 124 might be provided over the top of the weigh pan 104 after the fibers 112 and trash 110 have been received, so that air currents from other portions of the main system do not influence the weight measurements. In some embodiments, the barrier 124 might be in place for some specified length of time so that any air currents within the weigh pan 104 have time to die out to a desired level before the weight measurements are taken. In some embodiments an air flow sensor is used to determine whether the air currents are sufficiently calmed. In various embodiments, the barrier 124 is a sheet of rigid material, such as polymethyl metacrylate (PMMA), glass, metal, or wood, or a sheet of flexible material, such as cloth or plastic.

In this manner, the weighing apparatus 100 can be used and recycled in an automated fashion, without any manual intervention whatsoever. This tends to achieve several benefits. First, the cost of performing the weight measurements might decrease because less human operation and intervention is required. Second, the life and accuracy of the scale 102 might be increased, because it is not being handled in a harsh manner, as tends to be the case when people handle equipment. Third, the volume of samples to be tested might be increased due to higher test speed. Fourth, the precision and objectiveness of test results might be higher due to less human intervention. All of these might tend to produce both more accurate readings and a lower cost of performing the trash analysis of the fiber sample.

In some embodiments, where it is desirable to further isolate the scale 102 from the effects of physical vibration or shock during the cleaning cycle, a lifting system 122 can be employed to lift the weigh pan 104 off of the scale 106 during the cleaning and other portions of the cycle, and lower the weigh pan 104 on to the scale 106 during the weighing portions of the cycle. The lifting system 122 could take the form of, for example, rotating cams, pneumatic cylinders, or some other device that can lift the weigh pan 104 off of the scale 102 as desired, then lower the weigh pan 104 back on to the scale 102, and then continue to move out of physical contact with the weigh pan 104 so as to not disturb the scale 102 during the weighing portions of the cycle.

The foregoing description of embodiments for this invention has been presented for purposes of illustration and description. It is not intended to be exhaustive or to limit the invention to the precise form disclosed. Obvious modifications or variations are possible in light of the above teachings. The embodiments are chosen and described in an effort to provide illustrations of the principles of the invention and its practical application, and to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

1. A weighing apparatus for automatically weighing trash that is separated from a fiber sample, comprising:
a scale,
a weigh pan disposed on the scale,
a cleaner for passing a cleaning element across a surface of the weigh pan when the scale is not taking a weight measurement, and
a controller for selectively controlling operations and sequencing of the scale and the cleaner.

2. The weighing apparatus of claim 1, wherein the cleaning element comprises at least one of a brush, an air flow from a stationary air knife, a moving air nozzle, and a moving vacuum nozzle.

3. The weighing apparatus of claim 1, further comprising a lifting device to raise the weigh pan off of the scale during cleaning cycles and to lower the weigh pan on to the scale during weighing cycles, wherein the lifting device physically disengages from the weigh pan during the weighing cycles.

4. The weighing apparatus of claim 3, wherein the lifting device comprises at least one of rotating cams and pneumatic cylinders.

5. The weighing apparatus of claim 1, further comprising a barrier for selectively isolating the weigh pan from air currents during weighing cycles.

6. The weighing apparatus of claim 5, wherein the barrier comprises at least one of a rigid barrier and a cloth barrier.

7. The weighing apparatus of claim 1, further comprising a receptacle for receiving trash that is removed from the weigh pan by the cleaner.

8. The weighing apparatus of claim 7, further comprising a vacuum source connected to the receptacle for drawing away the trash that is removed from the weigh pan by the cleaner.

9. The weighing apparatus of claim 1, wherein the weigh pan comprises a box with openings in the top, first end, and opposing second end.

10. The weighing apparatus of claim 1, wherein the cleaner is an air knife and the controller selectively controls the air knife to produce a first air flow with a first velocity and then a second air flow with a second velocity, where the first velocity is lower than the second velocity.

11. A method for automatically weighing trash that is separated from a fiber sample, the method comprising the steps of:
receiving a first weight measurement from a scale with a controller at a first point in time when a weigh pan on the scale is free of trash,
collecting trash on the weigh pan,
receiving a second weight measurement from the scale with the controller at a second point in time when the weigh pan on the scale has collected the trash,
subtracting the first weight measurement from the second weight measurement to yield a weight of the collected trash, and
passing a cleaning element across the weigh pan using a cleaner, so as to remove substantially all of the collected trash from the weigh pan.

12. The method of claim 11, wherein the cleaning element comprises at least one of a brush, an air flow from a stationary air knife, a moving air nozzle, and a moving vacuum nozzle.

13. The method of claim 11, further comprising lifting the weigh pan off of the scale with a lifting device during cleaning cycles and lowering the weigh pan on to the scale with the lifting device during weighing cycles, wherein the lifting device physically disengages from the weigh pan during the weighing cycles.

14. The method of claim 11, further comprising drawing away the trash that is removed from the weigh pan by the cleaner with a receptacle that is connected to a vacuum source.

15. The method of claim 14, wherein the vacuum source connected to the receptacle produces a substantially turbulent flow of air within at least a portion of the weigh pan.

16. The method of claim 11, wherein the cleaner is an air knife and a controller selectively controls the air knife to produce a first air flow with a first velocity and then a second air flow with a second velocity, where the first velocity is lower than the second velocity.

17. The method of claim 11, wherein the cleaner is an air knife and an air pressure applied to the air knife produces a substantially laminar flow of air within at least a portion of the weigh pan that is substantially parallel to and adjacent a bottom of the weigh pan.

18. A weighing apparatus for automatically weighing trash that is separated from a fiber sample, comprising:
a scale,
a weigh pan disposed on the scale,
an air knife for passing a flow of air across a surface of the weigh pan when the scale is not taking a weight measurement, and
a controller for selectively controlling operations and sequencing of the scale and the air knife.

19. The weighing apparatus of claim 18, further comprising:
a receptacle for receiving trash that is removed from the weigh pan by the cleaner, and
a vacuum source connected to the receptacle for drawing away the trash that is removed from the weigh pan by the cleaner.

20. The weighing apparatus of claim 18, further comprising the controller programmed to selectively control the air knife to produce a first air flow with a first velocity and then a second air flow with a second velocity, where the first velocity is lower than the second velocity.
